(19) United States
(12) Patent Application Publication
(10) Pub. No.: US 2012/0062697 A1
(43) Pub. Date: Mar. 15, 2012

(54) Hyperspectral imaging sensor for tracking moving targets

(75) Inventors: Patrick Treado, Pittsburgh, PA (US); Matthew Nelson, Harrison City, PA (US); Charles Gardner, JR., Gibsonia, PA (US)

(73) Assignee: ChemImage Corporation, Pittsburg, PA (US)

(21) Appl. No.: 13/199,981

(22) Filed: Sep. 14, 2011

Related U.S. Application Data
(63) Continuation-in-part of application No. 12/802,642, filed on Jun. 9, 2010.
Application No. 12/802,642 is a continuation-in-part of application No. 13/068,542, filed on May 12, 2011.
Application No. 13/068,542 is a continuation-in-part of application No. 13/134,978, filed on Jun. 22, 2011.

(51) Int. Cl. H04N 13/00

(52) U.S. Cl. 348/42; 348/E13.001

(57) ABSTRACT

The present disclosure provides for a system and method for aerial detection, identification, and/or tracking of unknown ground targets. A system may comprise collection optics, a RGB detector, a SWIR MCF, a SWIR detector, and a sensor housing affixed to an aircraft. A method may comprise generating a RGB video image, a hyperspectral SWIR image, and combinations hereof. The RGB video image and the hyperspectral SWIR image may be analyzed to detect, identify, and/or track unknown targets. The RGB video image and the hyperspectral SWIR image may be generated simultaneously.

### RELATED APPLICATIONS

This application claims priority under 35 U.S.C. §119(e) to U.S. Provisional Patent Application No. 61/403,329, filed on Sep. 14, 2010, entitled “Hyperspectral Sensor for Tracking Moving Targets.” This application is also a continuation-in-part to the following pending U.S. patent application Ser. No. 12/802,642, filed on Jun. 11, 2010, entitled, “Portable System for Detecting Explosives and Method for Use Thereof”; Ser. No. 13/068,542, filed on May 12, 2011, entitled “Portable system for detecting hazardous agents using SWIR and method for use thereof”; and Ser. No. 13/134,978, filed on Jun. 22, 2011, entitled “Portable System for Detecting Explosive Materials Using Near Infrared Hyperspectral Imaging and Method for Use Thereof.” Each of these patent applications is hereby incorporated by reference in their entirety.

### BACKGROUND

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger targets, in the range of millimeter to meter dimensions, macro lens optics are appropriate. For samples located within relatively inaccessible environments, flexible fiberscope or rigid borescopes can be employed. For very large scale targets, such as planetary targets, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the entire area encompassing the sample simultaneously using an electronically tunable optical imaging filter such as an acousto-optic tunable filter (AOTF) or a LCTF. This may be referred to as “wide-field imaging”. Here, the organic material in such optical filters are actively aligned by applied voltages to produce the desired bandpass and transmission function. The spectra obtained for each pixel of such an image thereby forms a complex data set referred to as a hyperspectral image (HSI) which contains the intensity values at numerous wavelengths or the wavelength dependence of each pixel element in this image.

Spectroscopic devices operate over a range of wavelengths due to the operation ranges of the detectors or tunable filters possible. This enables analysis in the Ultraviolet (UV), visible (VIS), near infrared (NIR), short-wave infrared (SWIR), mid infrared (MIR) wavelengths and to some overlapping ranges. These correspond to wavelengths of about 180-380 nm (UV), 380-700 nm (VIS), 700-2500 nm (NIR), 850-1700 nm (SWIR), and 2500-25000 nm (MIR).

Currently, there exists a need to enhance aerial detection capabilities of targets on the ground. Hyperspectral imaging holds potential for enhancing a sensor's ability to maintain or re-acquire the track of a moving target based on the target's unique spectral signature. However, traditional sensors may be encumbered with scanning, framing and geolocation issues and can exhibit spectral distortions, mis-registration between spectral bands and aliasing. These sensors may offer only minimal tracking potential and are often pushed to their limits in capability and data storage capacity. It would be advantageous if a hyperspectral imaging system was configured so as to overcome these limitations and provide for aerial detection, identification, and/or tracking of a target.

### SUMMARY

The present disclosure relates to systems and methods for the aerial assessment of unknown targets. More specifically, the invention disclosed herein provides for the detection, identification, and/or tracking of unknown targets using RGB video and wide field hyperspectral SWIR imaging techniques.

Spectroscopic imaging may include multispectral or hyperspectral imaging. HSI combines high resolution imaging with the power of massively parallel spectroscopy to deliver images having contrast that define the composition, structure, and concentration of a sample. HSI records an image and a fully resolved spectrum unique to the material for each pixel location in the image. Utilizing a liquid crystal imaging spectrometer, SWIR images may be collected as a function of wavelength, resulting in a hyperspectral datacube where contrast is indicative of the varying amounts of absorbance, reflectance, scatter, or emission associated with the various materials present in the field of view (FOV). The hyperspectral datacube may be composed of a single spectroscopic method or a fusion of complimentary techniques.

The system and method of the present disclosure overcome the limitations of the prior art by providing an SWIR sensor for rapid, wide area, noncontact, and nondestructive aerial detection, identification, and/or tracking of unknown targets. The present disclosure provides for a sensor incorporating SWIR HSI combined with RGB video imaging which may be configured to for detection from a variety of aircrafts including Unmanned Aircraft Systems (UASs) and/or manned aircrafts. The invention of the present disclosure may be applied to at least the following operational scenarios: interrogation of suspect vehicles (at a checkpoint, parked along the roadway or travelling freely), interrogation of suspect individuals (at a checkpoint or an unstructured crowd); interrogation of suspect facilities or areas. The system and method of the present disclosure may also be used to detect explosive materials on surfaces such as metal, sand, concrete, skin, shoes, people, clothing, vehicles, baggage, entryways, concealments, and others. Examples of explosive materials that may be detected using the system and method disclosed herein include, but are not limited to: explosives selected from the group consisting of: nitrocellulose, Ammonium nitrate (“AN”), nitroglycerin, 1,3,5-trinitroperhydro-1,3,5-triazine (“RDX”), 1,3,5,7-tetranitroperhydro-2,3,5,7-tetrazocine (“HMX”) and 1,3,-Dinitrato-2,2-bis(nitratomethyl)propane (“PETN”), and combinations thereof.

The system and method of the present disclosure hold potential for meeting the current needs for interrogating suspect vehicles, suspect individuals or suspect facilities in a standoff, wide area surveillance and covert manner.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

The patent or application file contains at least one drawing executed in color. Copies of this patent or patent application publication with color drawing(s) will be provided by the Office upon request and payment of the necessary fee.

FIG. 1A is a schematic representation of exemplary packaging options of the present disclosure.

FIG. 1B is a schematic representation of a system of the present disclosure.

FIG. 2 is illustrative of an exemplary user interface of the present disclosure.

FIG. 3 is representative of exemplary operational features of the present disclosure.

FIG. 4 is illustrative of the capabilities of a Multi-Conjugate Filter.

FIG. 5 is representative of a method of the present disclosure.

FIGS. 6A-6C is illustrative of the detection capabilities of the present disclosure.

FIGS. 7A-7G is illustrative of the detection capabilities of the present disclosure.

FIG. 8 is illustrative of an exemplary operational configuration of the present disclosure.

FIGS. 9A-9B are illustrative of the detection capabilities of the present disclosure.

FIG. 10 is illustrative of the geolocation capabilities of the present disclosure.

FIG. 11 is illustrative of the target tracking capabilities of the present disclosure.

FIG. 12 is illustrative of the detection capabilities of the present disclosure.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts.

The present disclosure provides for a system and method that may be configured for aerial detection, identification, and/or tracking of unknown targets using SWIR HSI and RGB video imaging.

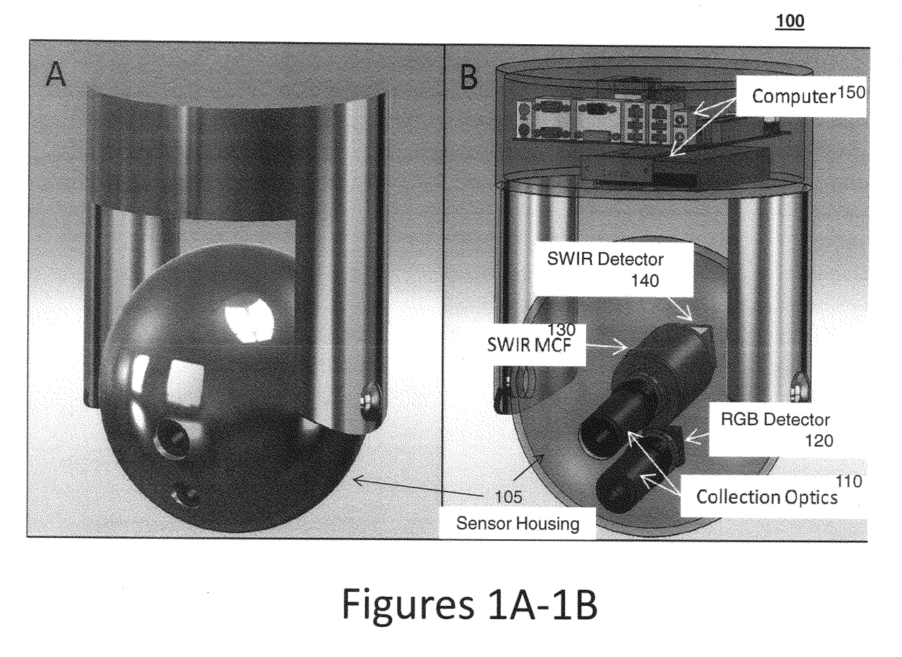

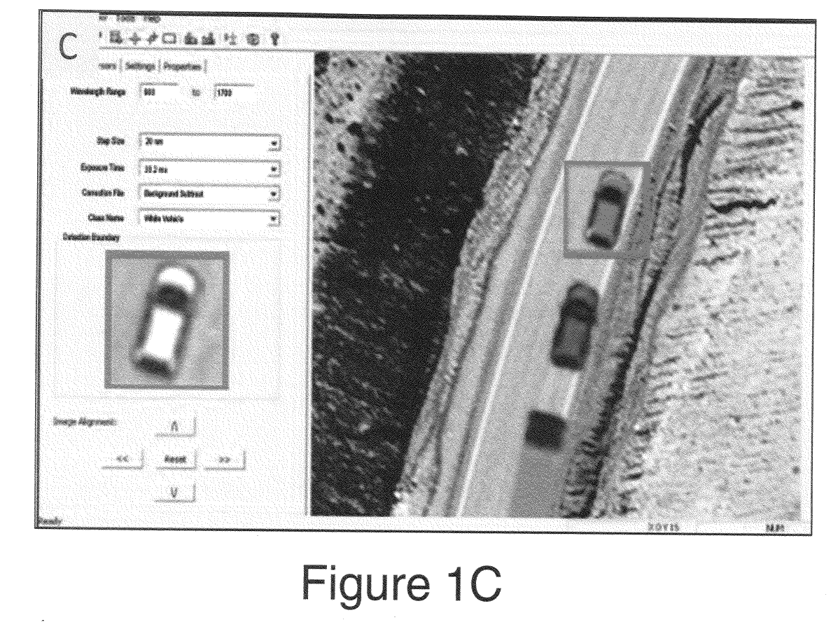

In one embodiment, the present disclosure provides for a system as illustrated in FIGS. 1A-1B. In FIG. 1A, exemplary packaging option of the system 100 are illustrated. FIG. 1B is illustrative of the component features of one embodiment of the present disclosure. In such an embodiment, the system 100 may comprise collection optics 110 configured to collect interacted photons from a region of interest comprising one or more unknown targets. In one embodiment, collection optics 110 may be small to allow for a smaller overall design of the system 110. In one embodiment, these interacted photons may be generated by illuminating a region of interest. This illumination may be achieved by using a passive illumination source, an active illumination source, and combinations thereof. Active illumination may be appropriate in nighttime and/or low light conditions and may utilize a laser light source and/or broadband light source. In one embodiment, a tunable laser light source may be utilized. Passive illumination may be appropriate in daytime and/or bright light conditions and may utilize solar radiation and/or ambient light.

In one embodiment, this illumination source may comprise at least one of: a solar light source, a broadband light source, an ambient light source, a laser light source, and combinations thereof. These interacted photons may be selected from the group consisting of: photon absorbed by said region of interest, photons reflected by said region of interest, photons emitted by said region of interest, photons scattered by said region of interest, and combinations thereof.

In one embodiment, first collection optics may be configured so as to collect a first plurality of interacted photons from a region of interest. This first plurality of interacted photons may be detected by a first detector to thereby generate a RGB video image. In the embodiment of FIG. 1B, this first detector may comprise a RGB detector 120. In one embodiment, this RGB detector 120 may comprise a CMOS RGB detector. A second collection optics may be configured so as to collect a second plurality of interacted photons from said region of interest. This second plurality of interacted photons may be passes through a filter. In one embodiment, this filter may comprise a fixed filter, a dielectric filter, a tunable filter, and combinations thereof. In an embodiment comprising a tunable filter, the tunable filter may be configured so as to sequentially filter said second plurality of interacted photons into a plurality of predetermined wavelength bands. In another embodiment, this filter may be selected from the group consisting of: a liquid crystal tunable filter, a multi-conjugate liquid crystal tunable filter, an acousto-optical tunable filter, a Lyot liquid crystal tunable filter, an Evans split-element liquid crystal tunable filter, a Solc liquid crystal tunable filter, a ferroelectric liquid crystal tunable filter, a Fabry Perot liquid crystal tunable filter, and combinations thereof.

In the embodiment of FIG. 1B, this filer may comprise an optical filter configured so as to operate in the short-wave infrared range of approximately 850-1700 nm (a SWIR MCF) 130. The multi-conjugate tunable filter is a type of liquid crystal tunable filter (“LCTF”) which consists of a series of stages composed of polarizers, retarders, and liquid crystals. The multi-conjugate tunable filter is capable of providing diffraction limited spatial resolution, and a spectral resolution consistent with a single stage dispersive monochromator. The multi-conjugate tunable filter may be computer controlled, with no moving parts, and may be tuned to any wavelength in the given filter range. This results in the availability of hundreds of spectral bands. In one embodiment, the individual liquid crystal stages are tuned electronically and the final output is the convolved response of the individual stages. The multi-conjugate tunable filter holds potential for higher optical throughput, superior out-of-band rejection and faster tuning speeds.

In one embodiment, this tunable filter may comprise filter technology available from ChemImage Corporation, Pittsburgh, Pa. This technology is more fully described in the following U.S. patents and patent applications: U.S. Pat. No. 6,992,809, filed on Jan. 31, 2006, entitled “Multi-Conjugate Liquid Crystal Tunable Filter,” U.S. Pat. No. 7,362,489, filed on Apr. 22, 2008, entitled “Multi-Conjugate Liquid Crystal Tunable Filter,” Ser. No. 13/066,428, filed on Apr. 14, 2011, entitled “Short wave infrared multi-conjugate liquid crystal tunable filter.” These patents and patent applications are hereby incorporated by reference in their entireties.

In one embodiment, this multi-conjugate filter may be configured with an integrated design. Such filters hold potential for increasing image quality, reducing system size, and reducing manufacturing cost. Such a design may enable integration of a filter, a camera, an optic, a communication means, and combinations thereof into an intelligent unit. This design may also comprise a trigger system configured to increase speed and sensitivity of the system. In one embodiment, this trigger may comprise a trigger TTL. The trigger may be configured so as to communicate a signal when various components are ready for data acquisition. The trigger may be configured to communicate with system components so that data is acquired at a number of sequential wavelengths. Such a design may hold potential for reducing noise. This integration may enable communication between the elements (optics, camera, filter, etc.). This communication may be between a filter and a camera, indicating to a camera when a filter ready for data acquisition.

In one embodiment, the filter may be configured with a square aperture. This square aperture configuration holds potential for overcoming the limitations of the prior art by increasing image quality and reducing system size and manufacturing costs. Such an embodiment enables the configuration of such filters to fit almost exactly on a camera, such as a CCD. This design overcomes the limitations of the prior art by providing a much better fit between a filter and a camera. This better fit may hold potential for utilizing the full CCD area, optimizing the field of view. This configuration holds potential for an optimized design wherein every pixel may have the same characteristic and enabling a high density image.

In one embodiment, the system 100 may further comprise a Fiber Array Spectral Translator (FAST) device. The FAST system can provide faster real-time analysis for rapid detection, classification, identification, and visualization of, for example, explosive materials, hazardous agents, biological warfare agents, chemical warfare agents, and pathogenic microorganisms, as well as non-threatening targets, elements, and compounds. FAST technology can acquire a few to thousands of full spectral range, spatially resolved spectra simultaneously, This may be done by focusing a spectroscopic image onto a two-dimensional array of optical fibers that are drawn into a one-dimensional distal array with, for example, serpentine ordering. The one-dimensional fiber stack is coupled to an imaging spectrograph. Software may be used to extract the spectral/spatial information that is embedded in a single CCD image frame.

One of the fundamental advantages of this method over other spectroscopic methods is speed of analysis. A complete spectroscopic imaging data set can be acquired in the amount of time it takes to generate a single spectrum from a given material. FAST can be implemented with multiple detectors. Color-coded FAST spectroscopic images can be superimposed on other high-spatial resolution gray-scale images to provide significant insight into the morphology and chemistry of the sample.

The FAST system allows for massively parallel acquisition of full-spectral images. A FAST fiber bundle may feed optical information from is two-dimensional non-linear imaging end (which can be in any non-linear configuration, e.g., circular, square, rectangular, etc.) to its one-dimensional linear distal end. The distal end feeds the optical information into associated detector rows. The detector may be a CCD detector having a fixed number of rows with each row having a predetermined number of pixels. For example, in a 1024-width square detector, there will be 1024 pixels (related to, for example, 1024 spectral wavelengths) per each of the 1024 rows.

The construction of the FAST array requires knowledge of the position of each fiber at both the imaging end and the distal end of the array. Each fiber collects light from a fixed position in the two-dimensional array (imaging end) and transmits this light onto a fixed position on the detector (through that fiber's distal end).

Each fiber may span more than one detector row, allowing higher resolution than one pixel per fiber in the reconstructed image. In fact, this super-resolution, combined with interpolation between fiber pixels (i.e., pixels in the detector associated with the respective fiber), achieves much higher spatial resolution than is otherwise possible. Thus, spatial calibration may involve not only the knowledge of fiber geometry (i.e., fiber correspondence) at the imaging end and the distal end, but also the knowledge of which detector rows are associated with a given fiber.

In one embodiment, the system 100 may comprise FAST technology available from Chemlmage Corporation, Pittsburgh, Pa. This technology is more fully described in the following U.S. patents and Published patent applications, hereby incorporated by reference in their entireties: U.S. Pat. Nos. 7,764,371, filed on Feb. 15, 2007, entitled “System And Method For Super Resolution Of A Sample In A Fiber Array Spectral Translator System”; 7,440,096, filed on Mar. 3, 2006, entitled “Method And Apparatus For Compact Spectrometer For Fiber Array Spectral Translator”; 7,474,395, filed on Feb. 13, 2007, entitled “System And Method For Image Reconstruction In A Fiber Array Spectral Translator System”; 7,480,033, filed on Feb. 9, 2006, entitled “System And Method For The Deposition, Detection And Identification Of Threat Agents Using A Fiber Array Spectral Translator”; and US 2010-0265502, filed on Apr. 13, 2010, entitled “Spatially And Spectrally Parallelized Fiber Array Spectral Translator System And Method Of Use.”

The second plurality of interacted photons may be detected using a second detector to thereby generate at least one hyperspectral data set representative of said region of interest. This hyperspectral data set may comprise at least one hyperspectral image. A hyperspectral image comprises an image and a fully resolved spectrum unique to the material for each pixel location in the image. In one embodiment, this second detector may comprise a SWIR detector 140. In one embodiment, this SWIR detector 140 may comprise a focal plane array detector. This focal plane array detector may be further selected from the group consisting of: an InGaAs detector, an InSb detector a MCT detector, and combinations thereof.

The system 100 may further comprise at least one computer and/or processor 150. In one embodiment, this processor 150 may comprise an embedded processor. Embedded processor technology holds potential for real-time processing and decision-making. The use of a MCF and embedded processor technology holds potential for achieving faster wavelength switching, image capture, image processing and explosives detection. The processor 150 may also be configured to store data collected during operation and/or reference libraries. These reference libraries may comprise reference RGB and/or SWIR data that may be consulted to detect, identify, and/or track an unknown target in a region of interest. In one embodiment, these reference images and reference spectra may be stored in the memory of the device itself. In another embodiment, the device may also be configured for remote communication with a host station using a wireless link to report important findings or update its reference library.

In one embodiment, the system 100 may further comprise a power source and/or display mechanism. A display mechanism may be configured so as to project a RGB video image and/or a hyperspectral SWIR image simultaneously or sequentially for inspection by a user. In an embodiment in which the system 100 is configured for operation in conjunction with an Unmanned Aircraft System, the display mechanism may be at a remote location from the unknown target and/or system for standoff detection. In one embodiment, this displaying may further comprise associating at least one pseudo color with a hazardous agent. In one embodiment, a pseudo color may be assigned to indicate the presence of a hazardous agent. In another embodiment, a pseudo color may be assigned to indicate the absence of a hazardous agent. In one embodiment, two or more pseudo colors may be used to correspond to two or more different materials in said hyperspectral image.

In one embodiment, the use of pseudo colors may comprise technology available from ChemImage Corporation, Pittsburgh, Pa. This technology is more fully described in pending U.S. Patent Application Publication No. US20110012916, filed on Apr. 20, 2010, entitled “System and method for component discrimination enhancement based on multispectral addition imaging,” which is hereby incorporated by reference in its entirety.

A power source may comprise at least one battery. The system 100 may be further enclosed in a sensor housing 105 which may be affixed to an aircraft. The present disclosure contemplates that a variety of aircraft may implement the system and method disclosed herein including but not limited to: Unmanned Aircraft Systems, manned aircraft systems, commercial aircraft, cargo aircraft, military aircraft, etc.

In one embodiment, the system 100 may further comprise one or more communication ports for electronically communicating with other electronic equipments such as a server or printer. In one embodiment, such communication may be used to communicate with a reference database or library comprising at least one of: a reference spectra corresponding to a known material and a reference short wave infrared spectroscopic image representative of a known material. In such an embodiment, the device may be configured for remote communication with a host station using a wireless link to report important findings or update its reference library.

The present disclosure contemplates a quick analysis time, measured in terms of seconds. For example, various embodiments may contemplate analysis time in the order of approximately <2 seconds. Therefore, the present disclosure contemplates substantially simultaneous acquisition and analysis of spectroscopic images. In one embodiment, the sensor may be configured to operate at speeds of up to 15-20 mph. One method for dynamic chemical imaging is more fully described in U.S. Pat. No. 7,046,359, filed on Jun. 30, 2004, entitled “System and Method for Dynamic Chemical Imaging”, which is hereby incorporated by reference in its entirety.

The system 100 may comprise embedded system parallel processor technology for real-time processing and decision-making that may be implemented in a device of the present disclosure. In one embodiment, this embedded processor technology may comprise Hyper-X embedded processor technology.

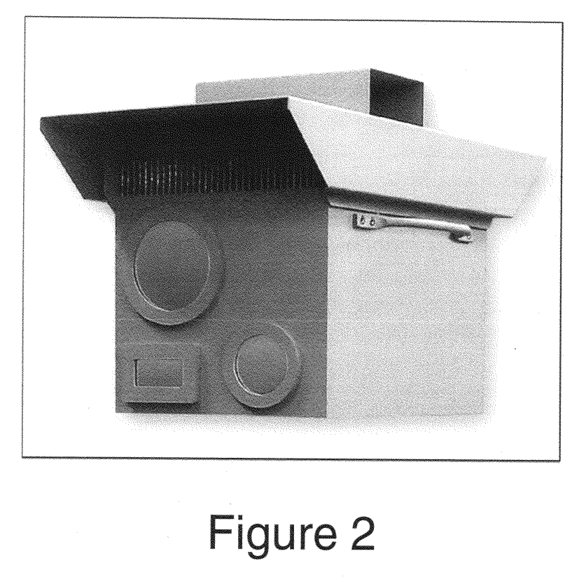

In one embodiment, the system 100 may be referred to commercially as the “SkyBoss” sensor. FIG. 2 is illustrative of a possible user interface associated with the system 100. In one embodiment, a conceptual design of the SkyBoss sensor may include miniaturized collection optics/cameras and a small embedded processor. The optics and cameras may be located in a ball pan tilt unit for easy control over the imaging region of interest.

In order for a system of the present disclosure to collect and generate hyperspectral images in real-time, the system may exploit technology available from ChemImage, Corporation, Pittsburgh, Pa. This technology may exploit its high switching speed Multi-Conjugate filter (MCF) imaging spectrometer technology, HyperX (or alternative) embedded processor technology and ChemImage's Real-Time Toolkit (RTTK) software user function. The MCF technology allows for higher speed hyperspectral image capture while the HyperX embedded processor enables real-time within-datacube image registration capability. In one embodiment, a GPS unit may also be incorporated for geolocation accuracy. The RTTK software user function may hold potential as the engine that drives the hyperspectral image acquisition.

The system 100 may be configured for widefield HSI. Widefield HSI technology involves collecting individual image frames as a function of wavelength through the use of a tunable filter. This approach has significant advantages over the pushbroom approach and addresses the main limitations of the prior art: spectral distortion/mis-registration and spectral aliasing; scanning issues; geolocation; capability; and storage capacity.

With respect to spectral distortion/mis-registration and spectral aliasing, with pushbroom sensors, the pixel size is defined by the velocity of the aircraft. A faster velocity will result in larger pixels. Spectral distortion can occur when two or more targets with different spectral signatures occur within a single pixel (which becomes more likely as the pixel size is larger). Additionally, the motion of the aircraft blurs the pushbroom pixels. As several lines of blurred pixels are collected, aliasing can result. Widefield HSI holds potential for overcoming these limitations because individual image frames are collected one at a time, the widefield approach is not susceptible to spectral distortions or aliasing.

With respect to scanning issues, widefield HSI holds potential for improving the ability to track a target. Widefield HSI allows for significant image redundancy of targets or object points. Overlapped images of a field of view are easily generated, therefore, a target will occur more often in the frames of a widefield image than in a single pixel line, where it can only appear once. If the pixel line of a pushbroom sensor passes over the target, subsequent lines may not contain the image of the target and tracking becomes impossible. Additionally, with pushbroom sensors, sudden uncompensated UAS motion (i.e. turbulence) can produce one or more missing lines of pixels. In this case, targets may also disappear from the image.

With respect to geolocation, pushbroom sensors produce raw images that have no internal photogrammetric accuracy due to the problems described in above, and therefore rely only on global positioning systems/inertial measurement units for geolocation. Widefield HSI, on the other hand, does produce photogrammetric accuracy and can therefore combine aerial-triangulation strategies with GPS measurements for higher geolocation accuracy.

With respect to capability, widefield HSI holds potential for providing a higher throughput than pushbroom sensors. The throughput of a pushbroom sensor is limited by the spectrometer slit width. A wider slit does allow higher throughput but results in a decrease in spectral resolution. In low light level situations, the exposure time on a widefield sensor can be increased to allow more light to reach the detector, without sacrificing spectral resolution.

With respect to storage capacity, the dataset that results from a pushbroom sensor, is often a single, large, “pixel carpet” of the entire flight pattern with a single file size that can exceed hundreds of Gigabytes. The widefield HSI approach collects numerous datasets with file sizes that typically won't exceed 500 Megabytes. The smaller file sizes make the data easier to store, manage and process.

Another potential challenge associated with tracking targets may be the mis-registration of images within a datacube, especially when operating in the following scenarios: moving sensor/stationary target, moving target/stationary sensor, moving target/moving sensor. This is due to the fact that a widefield approach involves collecting images as a function of wavelength. Image mis-registration within a datacube manifests itself as each frame in the datacube showing a slightly different scene with targets of interest likely changing position as well. The present disclosure provides for image registration methodologies to address image mis-registration problem. These methodologies hold potential for application to hyperspectral image registration for on-the-move detection of disturbed earth and explosives on the ground (moving sensor/stationary target) and detecting explosives on people/targets as they move through the imaging field of view (moving target/stationary sensor). The present disclosure also contemplates methodologies applicable to a moving sensor/moving target scenario. The potential of the present disclosure for refining image registration methodologies for a moving sensor/stationary target and for a moving target/stationary sensor holds potential or achieving a high likelihood of success for the moving target/moving sensor scenario.

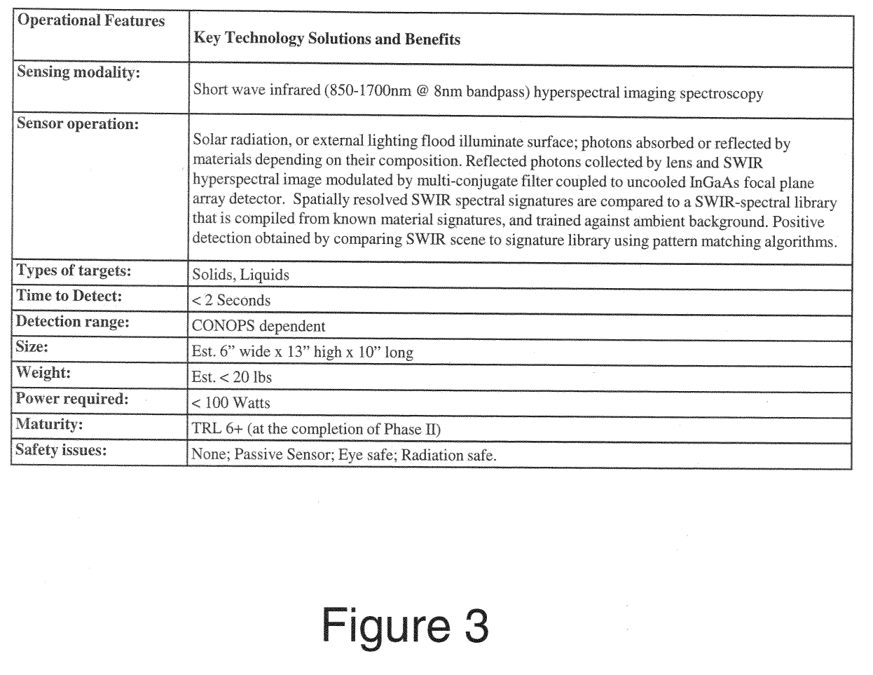

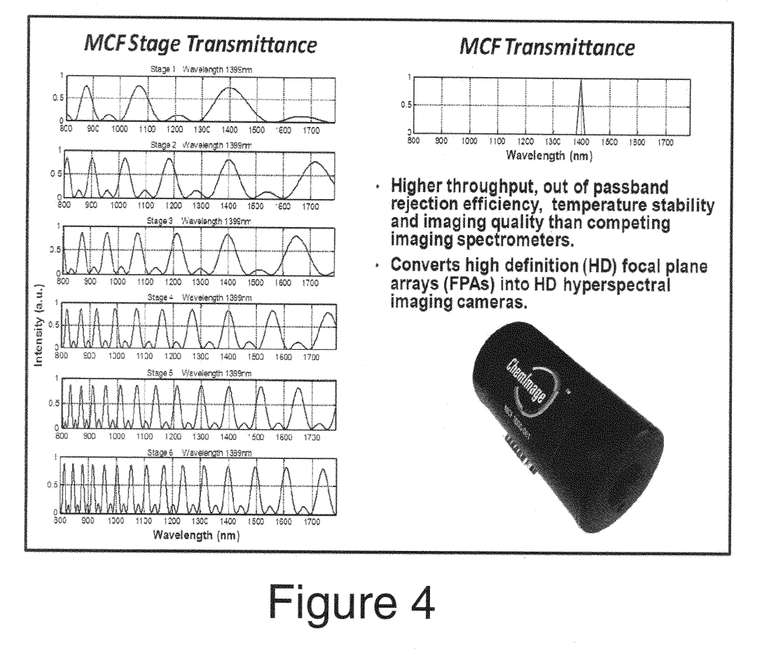

FIG. 3 is illustrative of exemplary operational features of one embodiment of the present disclosure. FIG. 4 is a schematic of the functionality of a MCF. A MCF, a type of liquid crystal tunable filter (LCTF), consists of a series of stages composed of polarizers, retarders and liquid crystals. A MCF is capable of providing diffraction limited spatial resolution, and a spectral resolution consistent with a single stage dispersive monochromator. With a Liquid Crystal-based imaging spectrometer such as the MCF, individual liquid crystal stages are tuned electronically, with the final spectral output representing the convolved response of the individual stages.

The MCF is computer controlled, with no moving parts, and can be tuned to any wavelength in the given filter range. This results in the availability of hundreds of discrete spectral bands. Compared to earlier generation LCTFs, MCF provides higher optical throughput, superior out-of-band rejection and faster tuning speeds. While images associated with spectral bands of interest must be collected individually, material-specific chemical images revealing target detections may be acquired, processed and displayed numerous times each second. Combining MCF technology with image registration methodology is central to the performance and capability of OTM SWIR HSI.

The present disclosure contemplates that data may be captured by rapid tuning of the MCF to a spectral band of interest followed by capturing that image of the scene with the InGaAs FPA. These images can be rapidly processed to create hyperspectral datacubes in real-time, that is, images where the observed contrast is due to the varying amount of absorbance/reflectance of the various materials present in the field of view. Each pixel in the image has a fully resolved spectrum associated with it; therefore each item in the field of view has a specific spectral signature that can be utilized for tracking purposes.

One limitation associated with tracking targets may be a time lapse between the acquisitions of images at different wavelength ranges. As the sensor platform moves, contents of the scene being imaged will change. Targets of interest will also likely change their relative positions in the images obtained. Due to this motion within the scene it is essential to align the common content of images acquired at different times so that the hyperspectral signature of a target of interest may be properly sampled.

RGB video images are collected simultaneously with the SWIR HSI datacubes, providing a mechanism for real-time image registration and image alignment of each frame in the hyperspectral datacube. Applying an image alignment methodology during the collection of the hyperspectral image is of the utmost importance.

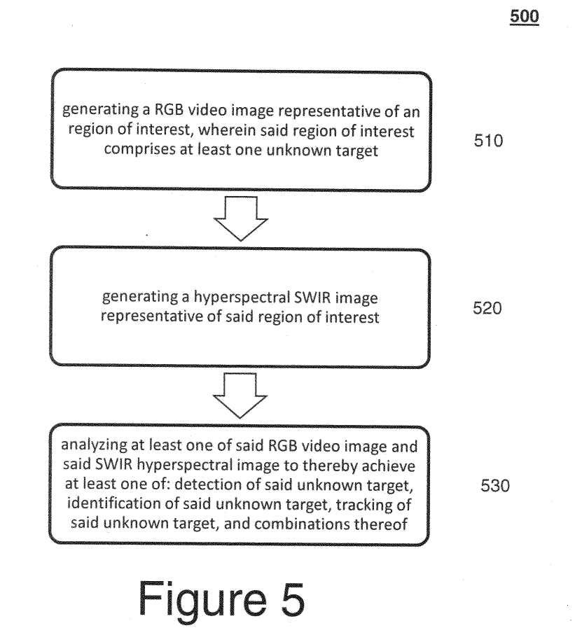

The present disclosure also provides for a method for aerially detecting, identifying and/or tracking unknown targets. One embodiment is illustrated by FIG. 5. In one embodiment, this method 500 may comprise generating a RGB video image representative of a region of interest, in step 510, wherein said region of interest comprises at least one unknown target. In step 520 a hyperspectral SWIR image may be generated representative of said region of interest. At least one of said RGB video image and said hyperspectral SWIR image may be analyzed in step 530 to thereby achieve at least one of: detection of said unknown target, identification of said unknown target, tracking of said unknown target, and combinations thereof.

In one embodiment, generating said hyperspectral SWIR image may further comprise: illuminating a region of interest to thereby generate a plurality of interacted photons, filtering said plurality of interacted photons, and detecting said plurality of interacted photons to thereby generate said hyperspectral SWIR image. In one embodiment, this illumination may be achieved using at least one of: a passive illumination source, an active illumination source, and combinations thereof. Filtering may be achieved by a filter as described herein, which may comprise least one of: a fixed filter, a dielectric filter, a tunable filter and combinations thereof.

In one embodiment, a RGB video image of step 510 and a hyperspectral SWIR image of step 520 may be generated simultaneously. The method 500 may also further comprising fusing said RGB video image and said hyperspectral SWIR image to thereby generate a hybrid image. This hybrid image may be further analyzed to thereby achieve at least one of: detection of an unknown target, identification of an unknown target, tracking of an unknown target, and combinations thereof.

The method 500 may further comprise providing a reference library/database comprising at least one reference data set, wherein each said reference data set is associated with at least one known target. In one embodiment, a reference data set may comprise at least one of: a spectrum associated with a known target, a spatially accurate wavelength resolved image associated with a known target, a hyperspectral image associated with a known target, and combinations thereof. This hyperspectral image may comprise a hyperspectral SWIR image associated with a known target.

The hyperspectral SWIR image generated in step 520 may be compared to at least one reference data set in this reference database. In one embodiment, this comparison may be achieved by applying at least one chemometric technique. This technique may be selected from the group consisting of: principle components analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof.

The system and method of the present disclosure may be utilized to detect, identify, and/or track a variety of targets. These may include, but are not limited to: disturbed earth, an explosive material, an explosive residue, a command wire, a concealment material, a biological material, a chemical material, a hazardous material, a non-hazardous material, and combinations thereof. The method 500 may also comprise performing geolocation of said unknown target.

In one embodiment, the method 500 may be automated using software. In one embodiment, the invention of the present disclosure may utilize machine readable program code which may contain executable program instructions. A processor may be configured to execute the machine readable program code so as to perform the methods of the present disclosure. In one embodiment, the program code may contain the ChemImage Xpert® software marketed by ChemImage Corporation of Pittsburgh, Pa. The ChemImage Xpert® software may be used to process image and/or spectroscopic data and information received from the portable device of the present disclosure to obtain various spectral plots and images, and to also carry out various multivariate image analysis methods discussed herein.

The present disclosure also provides for a storage medium containing machine readable program code, which, when executed by a processor, causes said processor to aerially assess an unknown ground target, said assessing comprising: generating a RGB video image representative of an region of interest, wherein said region of interest comprises at least one unknown target; generating a SWIR hyperspectral image representative of said region of interest; analyzing at least one of said RGB video image and said SWIR hyperspectral image to thereby achieve at least one of: detection of said unknown target, identification of said unknown target, tracking of said unknown target, and combinations thereof. The storage medium, when executed by a processor, may further cause said processor to compare said hyperspectral SWIR image to at least one reference data set in a reference database, wherein each said reference data set is associated with a known target. The storage medium, when executed by a processor, may further cause said processor to fuse said RGB video image and said hyperspectral SWIR image to thereby generate a hybrid image representative of said region of interest. The storage medium, when executed by a processor, may further cause said processor to generate said RGB video image and said hyperspectral SWIR image simultaneously.

In one embodiment, this fusion may be accomplished using Bayesian fusion. In another embodiment, this fusion may be accomplished using technology available from Chemlmage Corporation, Pittsburgh, Pa. This technology is more fully described in the following pending U.S. patent application: No. US2009/0163369, filed on Dec. 19, 2008 entitled “Detection of Pathogenic Microorganisms Using Fused Sensor Data,” Ser. No. 13/081,992, filed on Apr. 7, 2011, entitled “Detection of Pathogenic Microorganisms Using Fused Sensor Raman, SWIR and LIBS Sensor Data,” No. US2009/0012723, filed on Aug. 22, 2008, entitled “Adaptive Method for Outlier Detection and Spectral Library Augmentation,” No. US2007/0192035, filed on Jun. 9, 2006, “Forensic Integrated Search Technology,” and No. US2008/0300826, filed on Jan. 22, 2008, entitled “Forensic Integrated Search Technology With Instrument Weight Factor Determination.” These applications are hereby incorporated by reference in their entireties.

In one embodiment, the method 500 may further comprise generating an RGB image of a sample scene and/or target to scan an area for suspected hazardous agents (a targeting mode). A target can then be selected based on size, shape, color, or other feature, for further interrogation. This target may then be interrogated using SWIR for determination of the presence or absence of a hazardous agent. In such an embodiment, a RGB image and a SWIR hyperspectral image may be displayed consecutively. In one embodiment, the SWIR hyperspectral image and the RGB image may be displayed simultaneously. This may enable rapid scan and detection of hazardous agents in sample scenes.

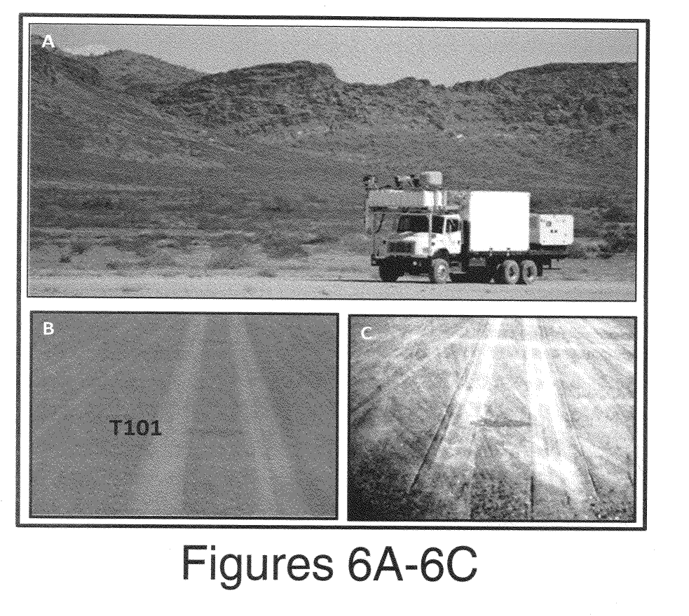

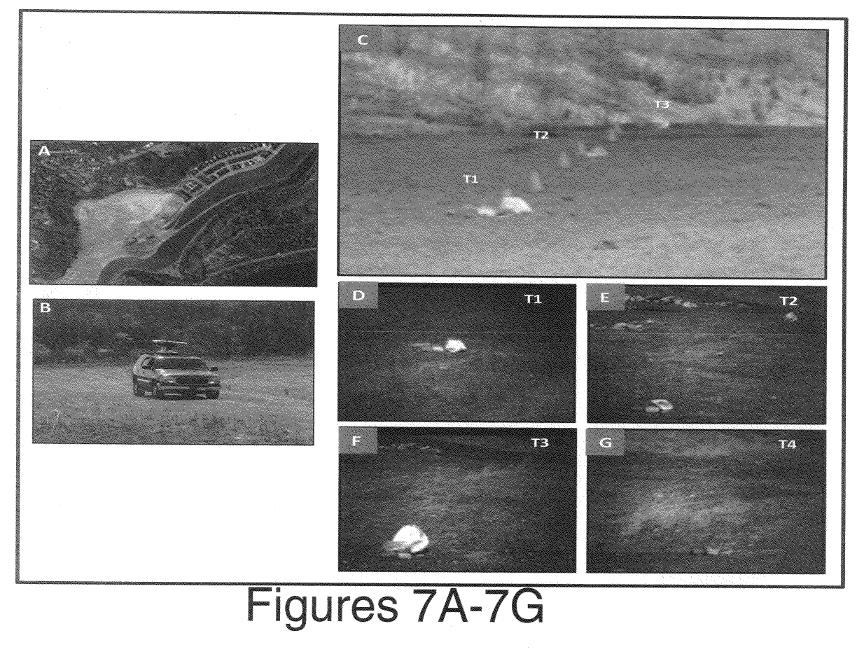

FIGS. 6A-6C show an example of disturbed earth detection at a 70 m standoff distance. FIG. 6A shows the SWIR HSI sensor mounted to the military vehicle; FIG. 6B shows the RGB video image of disturbed earth (Target 101); and FIG. 6C shows the disturbed earth detection (green) overlayed on the SWIR reflectance image. While FIGS. 7A-7G show OTM detection of Ammonium Nitrate (AN) on the ground. FIG. 7A shows the aerial view of the slag dump where data was collected; FIG. 7B shows the SWIR HSI sensor mounted to an SUV; FIG. 7C shows a digital photograph of the Ammonium Nitrate Targets; FIGS. 7D-7G show the detection of AN (red) overlayed on the SWIR reflectance image.

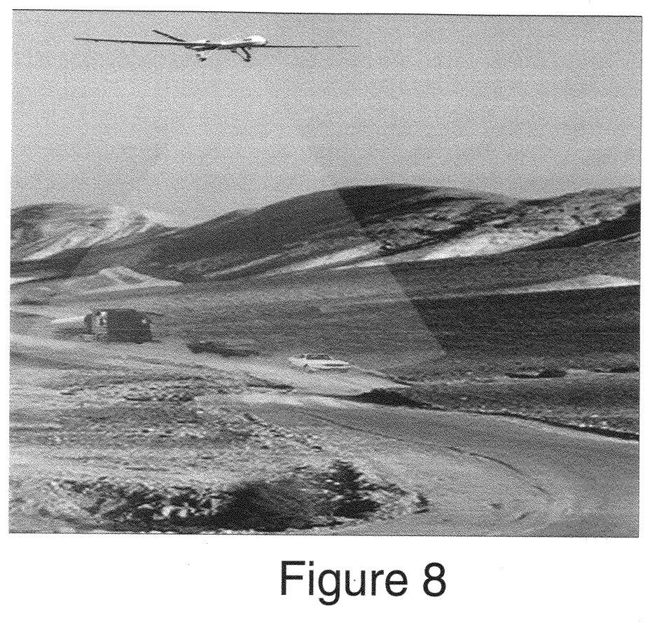

In one embodiment, a system of the present disclosure may be configured to collect hyperspectral imaging datasets from an UAS over a region of interest. The hyperspectral images may then be evaluated by a user, who will identify a particular target, and subsequently track it throughout the image frames using its spectral signature. An illustration of one operational configuration is shown by FIG. 8, in which a system enables collection of hyperspectral image datasets which can be used to track targets of interest.

The present disclosure also provides for an embodiment comprising definition of the expected targets and backgrounds. By defining the expected targets and backgrounds, the present disclosure holds potential for ensuring that the appropriate signatures are captured in the spectral library.

Table 1 provides an exemplary embodiment of a system of the present disclosure.

TABLE 1

| Sensor Characteristic | SkyBoss Sensor | |
|---|---|---|
| Spectral range | 900-1700 | nm |
| Spectral Resolution | 8-18 | nm |
| F-number | F/8.2 | |
| Throughput | 0.000465 m2 * sr | |
| Sensor Geometry (pixels) | 640 × 512 | |
| Pixel Size | 25 | um |
| Frame Speed | 30 | fps |
| Available spectral bands | Hundreds | |
| Active Cooling Required? | No | |
| Application | Detect vehicles | |
| | and people | |
| Total Weight | <20 | lbs |

| | |
|---|---|
| HSI Methodology | Widefield |

Widefield SWIR HSI holds potential for aerial detection, identification, and tracking of unknown ground targets. HSI combines high resolution imaging with the power of massively parallel spectroscopy to deliver images having contrast that define the composition, structure and concentration of a wide variety of materials.

The absorption bands associated with the SWIR region of the spectrum generally result from overtones and combination bands of O—H, N—H, C—H and S—H stretching and bending vibrations. The molecular overtones and combination bands in the SWIR region are typically broad, leading to complex spectra where it can be difficult to assign specific chemical components to specific spectral features. However, by taking advantage of multivariate statistical processing techniques, we can generally extract the important chemical information. With SWIR HSI, each pixel in the image has a fully resolved SWIR spectrum associated with it; therefore multiple components in the field of view will be distinguishable based on the varying absorption that the materials exhibit at the individual wavelengths. The individual components of interest are uniquely identified based on the absorbance properties. This method yields a rapid, reagentless, nondestructive, non-contact method capable of fingerprinting trace materials in a complex background.

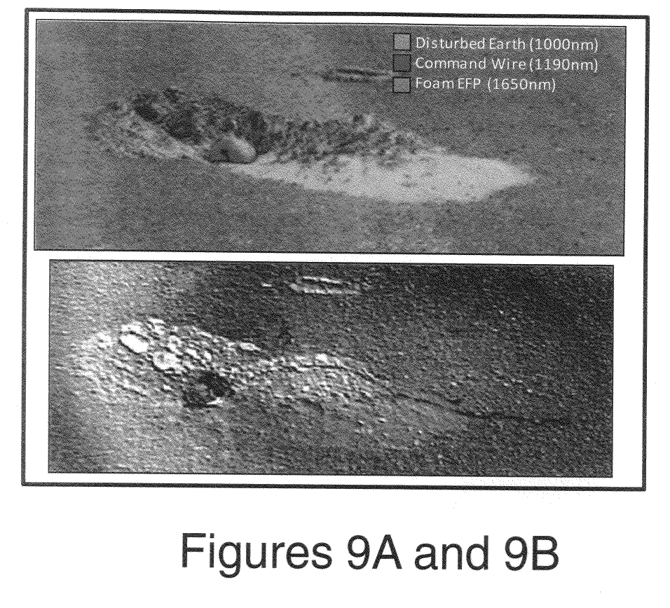

FIG. 9A shows the detection image associated with an RGB image of a scene containing disturbed earth (detection showed in green), command wire (detection shown in blue) and foam EFP camouflage (detection shown in red). FIG. 9B shows a SWIR hyperspectral image extract.

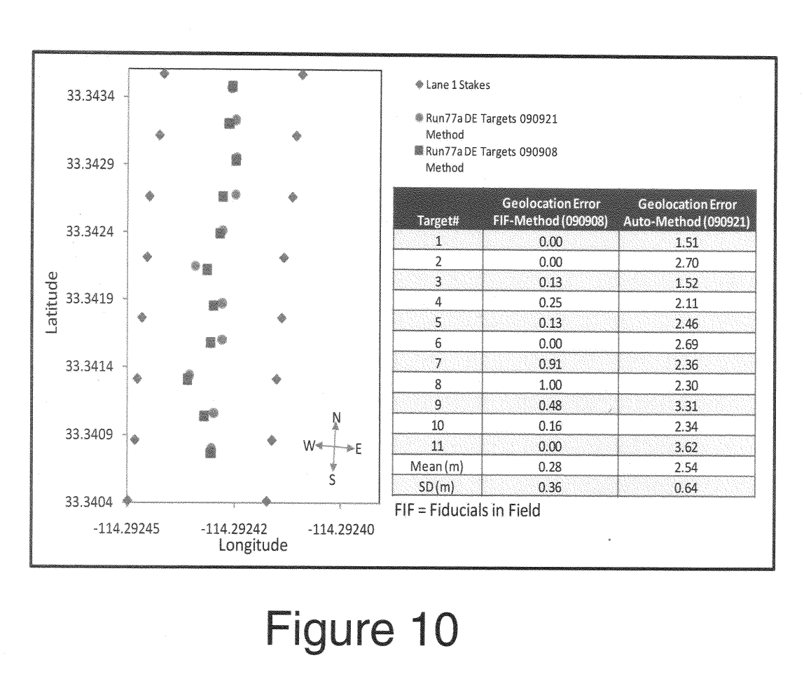

The present disclosure also provides for methodologies for geolocation. FIG. 10 shows the accuracy of these geolocation measurements. At least two methods hold potential for geolocation: a Fiducials in Field (FIF) method and an Auto method. The FIF method may involve using targets of known locations in the field of view as points of reference and manually calculating the distance to the detection. The auto method may utilize a software algorithm that takes into account GPS readings and other parameters from the sensor and automatically calculated the position of the detection. FIG. 10 is illustrative of the potential geolocation accuracy of the SWIR HSI Sensor for ground-based detections.

In one embodiment, the design of the present disclosure may include evaluating specifications for a fixed lens that fulfills the ground sampling distance (GSD) requirements (1 m for vehicles and 0.5 m for dismounts) at altitudes from 5-25 k feet as specified in the solicitation. In one embodiment, this lens may be incorporated into a system of the present disclosure. Additionally, the present disclosure contemplates the use of low power consumption electronics. A system of the present disclosure may also include an OEM module FPA, rather than a full size camera module.

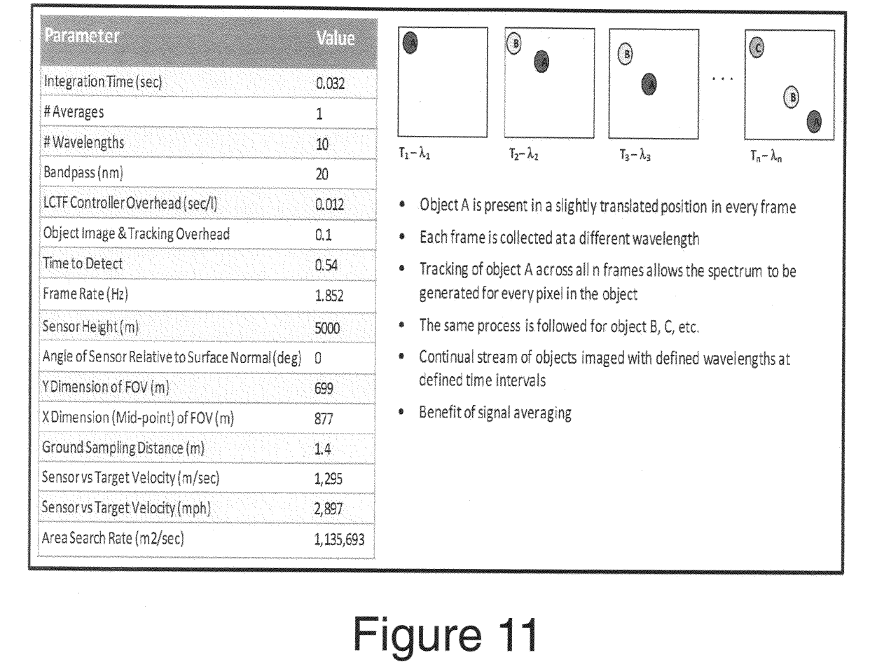

The present disclosure also contemplates the use of algorithms for hyperspectral target tracking at video frame rates (≧30 Hz). These may be used to perform alignment on the common areas of images obtained at different bandwidths (global motion estimation) and from this aligned imagery determine the collection of pixels (if any) that belong to moving targets (local motion estimation). The dynamics of targets determined to be moving targets may be estimated at video frame rates. The type of global and local motion estimation algorithms that are employed to detect and track moving targets may affect the imaging performance. One such method is illustrated in FIG. 11. This method takes into account specifications such as number of wavelengths, frame rate, sensor height, and ground sampling distance to determine the maximum sensor vs. target velocity that would be allowed for the image alignment to be correctly applied.

In the example shown in FIG. 11, because of the distance of the UAS from the ground, targets may appear to move slowly with respect to the sensor, regardless of the actual speeds of the target or the UAS. This may allow for easier alignment of image frames within the hyperspectral datacube. As calculated above, this method could handle a sensor vs. target velocity of nearly 2,900 mph. Of course as the number of wavelengths increases or decreases (the present invention is not limited to 10), or as the sensor height and/or GSD changes, the sensor vs. target velocity calculation will change as well.

Another image alignment strategy involves acquiring RGB imagery at the same time as SWIR imagery with alignment performed by registering the SWIR hyperspectral image with the RGB imagery. The 3D registration between the RGB and SWIR cameras is then used to map transformations between RGB images to transformations in SWIR images. The advantage of using RGB images for alignment is that the same targets will have the same intensities in sequential images (notwithstanding noise). Another advantage is that a much higher frame rate (30 Hz) with a higher image resolution can be used to export information than with SWIR images alone.

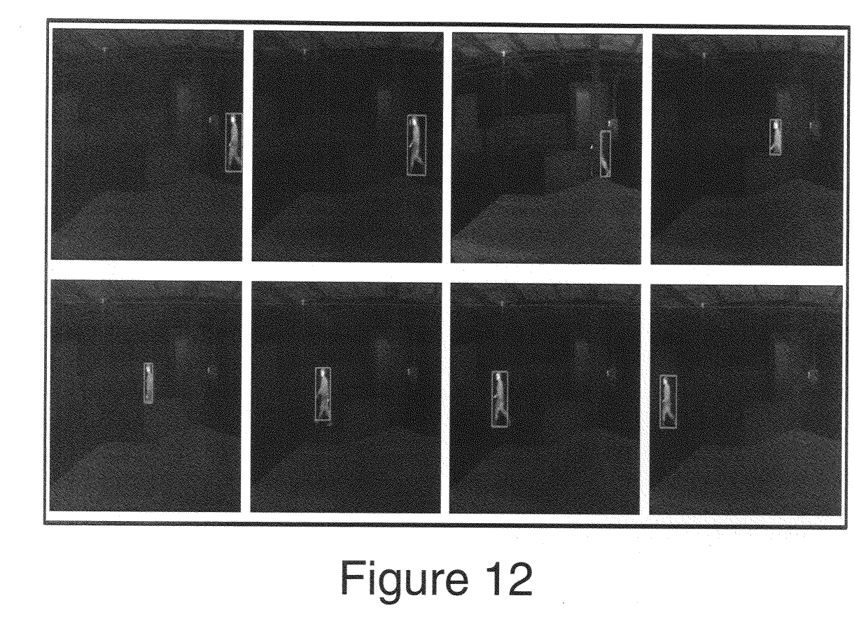

FIG. 12 is illustrative of the capability of the present invention for detecting and tracking targets through a scene. The box in the LWIR image shows the detection and tracking of the human target in the scene. Although FIG. 12 is illustrative of the use of LWIR, the present discourse contemplates similar capabilities with the use of RGB video and/or SWIR HSI.

In one embodiment, a primary technical requirement associated the present disclosure may be the need for a platform that provides sufficient computational performance, software programmability and efficient power consumption. Current commercial off-the-shelf digital signal processor (COTS DSP) technology may provide straightforward programmability, but cannot readily support real-time computational performance associated with image registration requirements and low power requirements associate with our objectives. Application-specific integrated circuit technology can potentially provide sufficient computational performance and efficient power consumption, but entails high development costs and difficult programmability.

The Coherent Logix HyperX massively parallel processor represents a leap forward in what is possible in software defined systems focusing on real-time processing, wide bandwidth, and efficient power consumption. Through a system-on-a-chip framework, the HyperX architecture enables advanced signal processing algorithms to be readily programmed, reconfigured, updated, and scaled. The HyperX hx3100 chip has 100 processing elements (cores) that can produce up to 50,000 million instructions per second (MIPS) with as low as 13 pJ per mathematical operation. This enables state-of-the-art high performance processing and data throughput on a low power device, ranging from 100 mW to 3.5 W. When compared with legacy hybrid field programmable gate array (FPGA)/general purpose processor (GPP)/DSP systems, platforms based on HyperX have demonstrated a power reduction by a factor of 10 and development time reduction by a factor of 5. A 32K Fast Fourier Transform (FFT) (for rapid wideband spectrum assessment) operating on data sampled at 500 MIPS can be performed in 65 μs. However, the present disclosure is not limited to the use of such technology and contemplates the use of any technology in the art that achieves the required functionality may be used.

Although the disclosure is described using illustrative embodiments provided herein, it should be understood that the principles of the disclosure are not limited thereto and may include modification thereto and permutations thereof.

What is claimed is:

1. A method for aerially assessing an unknown target, the method comprising:
generating a RGB video image representative of an region of interest, wherein said region of interest comprises at least one unknown target;
generating a hyperspectral SWIR image representative of said region of interest;
analyzing at least one of said RGB video image and said SWIR hyperspectral image to thereby achieve at least one of: detection of said unknown target, identification of said unknown target, tracking of said unknown target, and combinations thereof.

2. The method of claim 1 wherein said generating said hyperspectral SWIR image further comprises:
illuminating a region of interest to thereby generate a plurality of interacted photons,
filtering said plurality of interacted photons; and
detecting said plurality of interacted photons to thereby generate said hyperspectral SWIR image.

3. The method of claim 2 wherein said illumination is achieved using at least one of: a passive illumination source, an active illumination source, and combinations thereof.

4. The method of claim 2 wherein said filtering further comprises passing said plurality of interacted photons through a filter selected from the group consisting of: a fixed filter, a dielectric filter, and combinations thereof.

5. The method of claim 2 wherein said filtering further comprises passing said plurality of interacted photons through a tunable filter to thereby sequentially filter said plurality of interacted photons into a plurality of predetermined wavelength bands.

6. The method of claim 1 wherein said RGB video image and said hyperspectral SWIR image are generated simultaneously.

7. The method of claim 1 further comprising fusing said RGB video image and said hyperspectral SWIR image to thereby generate a hybrid image representative of said region of interest.

8. The method of claim 7 further comprising analyzing said hybrid image to thereby achieve at least one of: detection of said unknown target, identification of said unknown target, tracking of said unknown target, and combinations thereof.

9. The method of claim 1 further comprising providing a reference database comprising at least one reference data set wherein each said reference data set is associated with at least one known target.

10. The method of claim 9 wherein at least one reference data set comprises at least one of: a spectra associated with a known target, a spatially accurate wavelength resolved image associated with a known target, and combinations thereof.

11. The method of claim 9 wherein at least one reference data set comprises at least one hyperspectral SWIR image associated with a known target.

12. The method of claim 9 wherein said analyzing further comprises comparing said hyperspectral SWIR image to at least one said reference data set.

13. The method of claim 9 wherein said comparing is achieved by applying at least one chemometric technique.

14. The method of claim 13 wherein said chemometric technique is selected from the group consisting of: principle components analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof.

15. The method of claim 1 wherein said unknown target comprises at least one of: disturbed earth, an explosive material, an explosive residue, a command wire, a concealment material, and combinations thereof.

16. The method of claim 1 wherein said unknown target comprises at least one of: a biological material, a chemical material, a hazardous material, a non-hazardous material, and combinations thereof.

17. The method of claim 1 further comprising performing geolocation of said unknown target.

18. The method of claim 1 further comprising passing said second plurality of interacted photons through a fiber array spectral translator device.

19. A storage medium containing machine readable program code, which, when executed by a processor, causes said processor to aerially assess an unknown ground target, said assessing comprising:
generating a RGB video image representative of an region of interest, wherein said region of interest comprises at least one unknown target;
generating a SWIR hyperspectral image representative of said region of interest;
analyzing at least one of said RGB video image and said SWIR hyperspectral image to thereby achieve at least one of: detection of said unknown target, identification of said unknown target, tracking of said unknown target, and combinations thereof.

20. The storage medium of claim 19 wherein said machine readable program code, when executed by a processor, further causes said processor to compare said hyperspectral SWIR image to at least one reference data set in a reference database, wherein each said reference data set is associated with a known target.

21. The storage medium of claim 19 wherein said machine readable program code, when executed by a processor, further causes said processor to fuse said RGB video image and said hyperspectral SWIR image to thereby generate a hybrid image representative of said region of interest.

22. The storage medium of claim 19 wherein said machine readable program code, when, executed by a processor, further causes said processor to generate said RGB video image and said hyperspectral SWIR image simultaneously.
